(19) United States
(12) Patent Application Publication
(10) Pub. No.: US 2009/0132370 A1
(43) Pub. Date: May 21, 2009

(54) System And Method For Internet Marketing And Branding

(76) Inventor: Artoosh Peshkam, Diamond Bar, CA (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/273,227

(22) Filed: Nov. 18, 2008

Related U.S. Application Data
(60) Provisional application No. 60/988,946, filed on Nov. 19, 2007.

(51) Int. Cl. G06Q 30/00

(52) U.S. Cl. 705/14

(57) ABSTRACT

A system, method and computer program product for online advertising, including providing a branded prefix have a secondary meaning; appending the branded prefix to a dictionary word suffix to form a domain name; and displaying a web page based on the domain name and including one or more web page links. The one or more web page links within the web page are related to the dictionary word and the secondary meaning.

### CROSS REFERENCE TO RELATED DOCUMENT

The present invention claims benefit of priority to U.S. Provisional Patent Application Ser. No. 60/988,946 of Artoosh PESHKAM, entitled “SYSTEM AND METHOD FOR INTERNET MARKETING AND BRANDING,” filed on Nov. 19, 2007, the entire content of which is hereby incorporated by reference herein.

### BACKGROUND OF THE INVENTION

1. Field of the Invention

The present invention generally relates to systems and methods for marketing and advertising, and more particularly to a method and system for Internet-based marketing and advertising.

2. Discussion of the Background

Due to the recent hype, over 128 million domain names have been registered to date, while most are not even dictionary words anymore. Over 90% of the registered domain names are either not active or simply “Parked” as referred to in the domain name art, since most people think someone is going to offer them large sums of money, basically for doing nothing more than registering a domain. Over 95% of Small and Medium Enterprises (SMEs) have long multiple-word domain names, which are easily forgotten, with respect to their name or exact spelling. Accordingly, all of the relatively valuable branded domain names have been registered many years ago.

### SUMMARY OF THE INVENTION

Therefore, there is a need for a method and system that addresses the above and other problems. The above and other problems are addressed by the exemplary embodiments of the present invention, which provide a system and method, including a brandable prefix (e.g., “104” having secondary meaning “ten four”) appended to numerous (e.g., over 1,200) single-word domain names in order to save time, assist with ease of remembering the corresponding (Universal Resource Locators) URL's, and to provide an efficient means for customers/users to maneuver through the Internet and acquire desired business information. Advantageously, advertised businesses within the “104” community are automatically advertising for other businesses within that industry (e.g., Medical, Legal, Mortgage, etc). Through the “104” community, businesses can gain high Internet marketing and advertising exposure from multiple domain names/website listings, and for example, while also having an opportunity to be the only business within their given area via geo-targeting technologies, and the like. Businesses can be listed to users based on IP addresses, desired zip code, and the like, and displayed as geographically targeted businesses with corresponding address, phone #, website address, and the like.

Accordingly, in exemplary aspects of the present invention there is provided a system, method and computer program product for online advertising, including providing a branded prefix have a secondary meaning; appending the branded prefix to a dictionary word suffix to form a domain name; and displaying a web page based on the domain name and including one or more web page links. The one or more web page links within the web page are related to the dictionary word and the secondary meaning.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is used to illustrate an exemplary system and business process flow, where an initial user ultimately obtains desired business information through a single-word domain and limited clicks;

FIG. 2 illustrates an exemplary system and business process flow for geo-targeting, providing ease of reaching desired information within a specified geographically region, based upon user needs; and

FIGS. 3-4 illustrate exemplary website screen shots representing an exemplary template that can be used for “104” branded domains.

### DETAILED DESCRIPTION OF THE PREFERRED EMBODIMENTS

Generally, the present invention is directed to an online system and method (e.g., Internet-based) for hosting and delivering, for example, geo-targeted advertising within a large family of brand-prefixed and managed website domains (e.g., “104” having secondary meaning “ten four”). In the following description, for purposes of explanation, numerous specific details are set forth in order to provide a thorough understanding of the exemplary embodiments of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

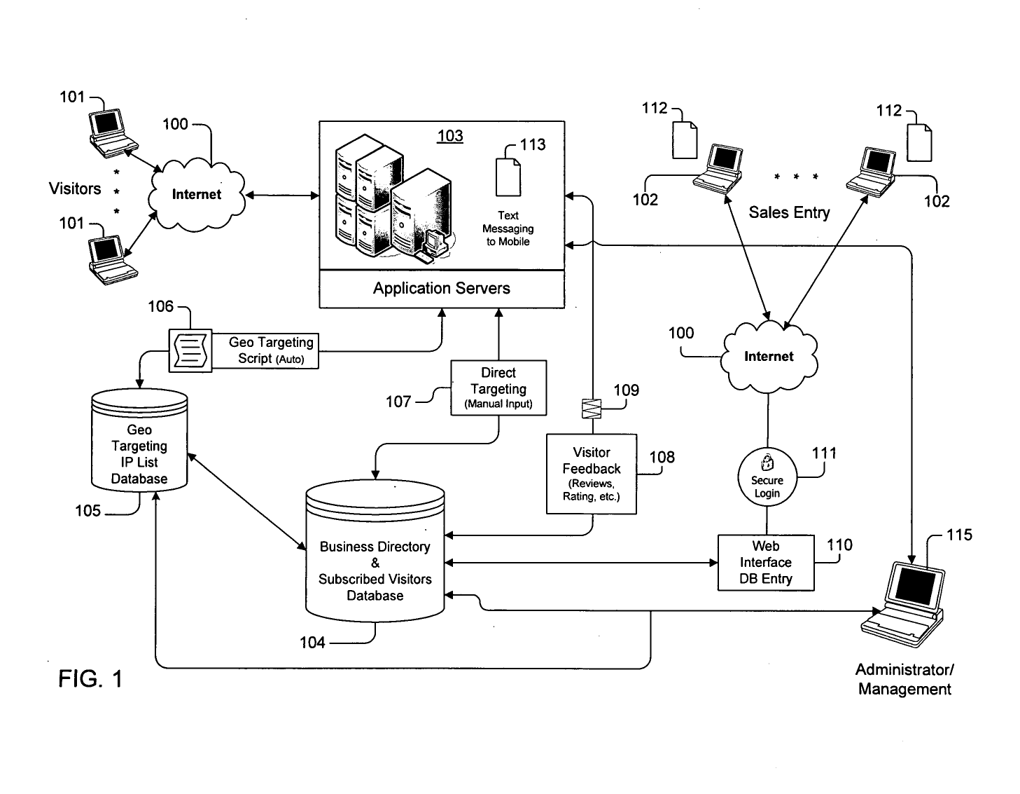

Referring now to the drawings, wherein like reference numerals designate identical or corresponding parts throughout the several views, and more particularly to FIG. 1 thereof, there is illustrated a process of hosting and delivering geo-targeted advertising within a large family of brand-prefixed and managed website domains, according to an embodiment of the present invention. In FIG. 1, generally, the geo-targeted managed advertising and hosting system provides a platform on which a system of delivering advertising content to region-specific clients can function.

The geo-targeted managed advertising and hosting system depicted in FIG. 1 allows visitors 101 to use the Internet 100 to search more quickly and efficiently for business websites that are organized in a business directory database 104 by means of a large family of brand-prefixed (e.g., “104” having secondary meaning “ten four”) and generic category suffixed (e.g., high value domain words, such as attorney(s), loan(s), etc.) website domains owned and controlled by a single entity, for example, earning revenue on a subscription-based advertising basis, and the like.

In an exemplary embodiment, a visitor 101 can use any suitable web browser software on their computer, Personal Digital Assistant (PDA), mobile phone, and the like, to visit a website within the family of brand-prefixed generic category suffixed website domains that are hosted within a farm of web servers 103. For example, a visitor wishing to obtain a list of law-related websites can visit “104Law.com,” “104Attorney.com,” and the like. A top-level directory web page is also available to visitors 101 for the purposes of viewing a complete list of available generic categories within the family of brand-prefixed websites. When the visitor 101 reaches the desired website, a geo-targeting scripting technology 106 programmed within each web page hosted on the web servers 103 can access a database of IP addresses and locations 105 in order to determine the geographical location of the visitor 101. Once the geographical location of visitor 101 is determined, the script 106 can perform an automatic search within a database of subscribed businesses 104 using the geographical location of visitor 101 as a filter so that the results from the database 104 search show only those businesses located within the same geographical region as the visitor 101.

In an exemplary embodiment, the visitor 101 also can subscribe to the business directory and database 104 of subscribed visitors and specify their desired geographical location via a manual step 107, instead of having the website perform geo-targeting via an automatic step 106, as described above. Thus, web pages within the family of brand-prefixed domains can include a link for visitors 101 to subscribe to the visitors database 104. Upon visiting the subscription link, the visitor 101 is presented with a form to fill out, including visitor-specific information and user preferences to control content presentation, provide private contact information to the website owner, and the like. A exemplary option of subscribing to a business within a specific geographical region is also available, for example, through a zip code search functionality, and the like.

In an exemplary embodiment, once the subscribed visitor 101 has obtained the business information they are searching for, the information can be added as a “favorite” to a personalized list within the visitor database 104 and/or the information can be sent via text messaging technology 113 to a mobile phone (e.g., with functionality provided for by cell phone carriers).

In an exemplary embodiment, the subscribed visitors 101 have the ability to submit their own feedback, reviews, and ratings 108 that can be stored within the business directory database 104 for other subscribed visitors to view. Prior to this information being posted on to the website, a filtering system 109 can be implemented, for example, where assigned staff members can execute surveillance on the visitor feedback 108 in order to ensure improper information and/or comments do not get posted. In further exemplary embodiments, automatic filtering can be employed, as will be appreciated by those skilled in the relevant art(s).

In an exemplary embodiment, business listing results from searches performed within the database 104 are presented to visitors 101 sorted from top to bottom via a star rating system as the criteria for sort priority. The business directory and subscribed visitor database 104 can be manually maintained by a team of sales and technical staff 102 or in further exemplary embodiments can be automatically maintained, as will be appreciated by those skilled in the relevant art(s). The staff can utilize the Internet 100 to access a secure login web page 111 to log into a web interface 110 that allows data entry directly into the business directory database 104. The web interface pages 110 are stored and hosted within the web server platform 103. In further exemplary embodiments, automatic processes can be employed to perform or all of the above processing steps, as will be appreciated by those skilled in the relevant art(s).

In an exemplary embodiment, various documents 112 and information can be entered into the sales computers by staff members. Such information can be utilized and added to by any suitable member of the sales team. For example, administrators/managers 115 can have access to both the business directory and subscribed visitor database 104 and the geo-targeting IP list database 105. The administrators/managers 115 can be able to access this information through the secure application servers 103. In further exemplary embodiments, automatic processes can be employed to perform or all of the above processing steps, as will be appreciated by those skilled in the relevant art(s).

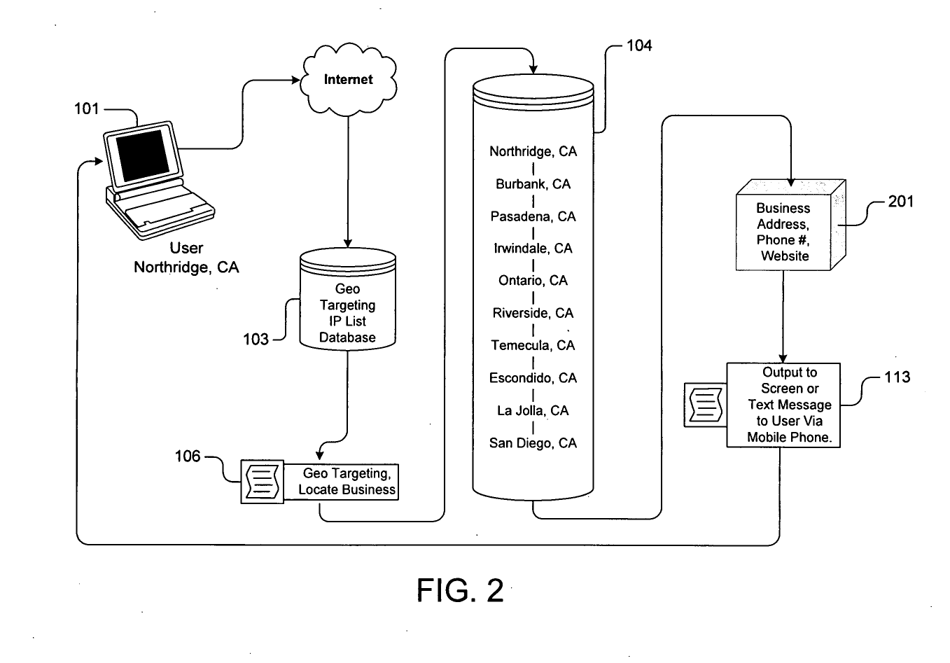

FIG. 2. illustrates further exemplary details of the geo-targeting scripting technology 106 programmed within each web page hosted on the web servers 103 that would access the desired business's address, phone#, website address 201, and the like. In an exemplary embodiment, such information can be viewed on screen and/or the information can be sent via text messaging technology 113 to a mobile phone, PDA, and the like.

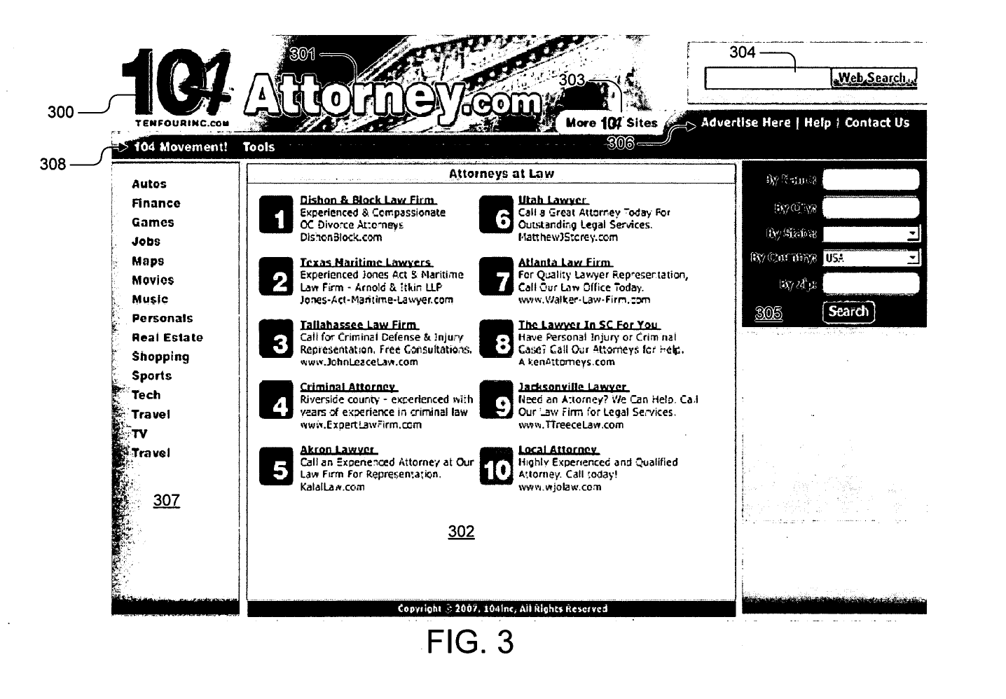

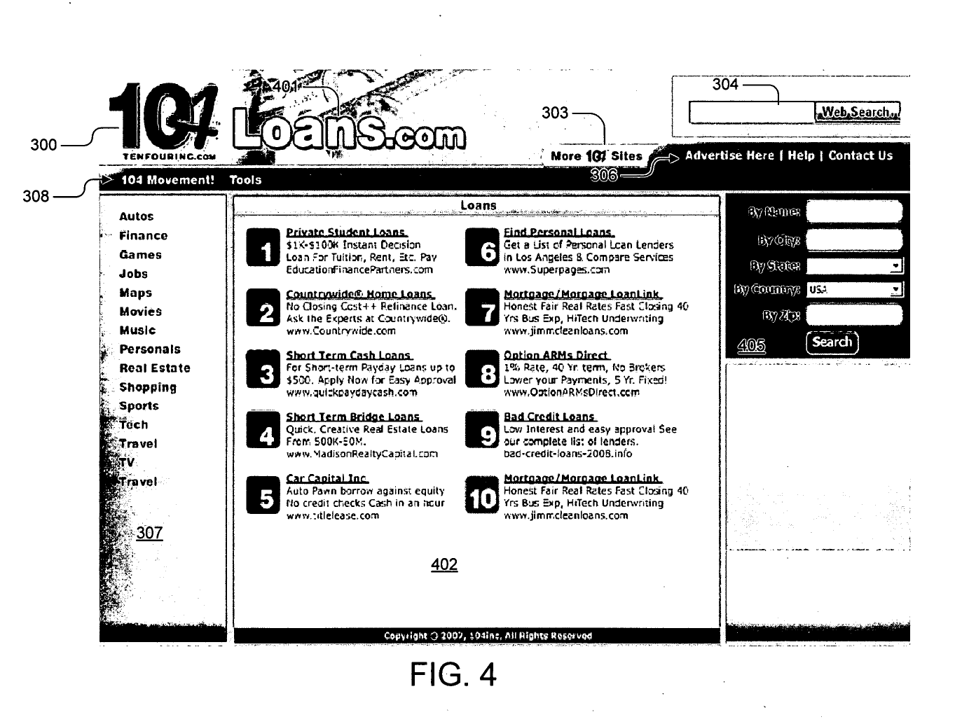

FIGS. 3-4 illustrate exemplary website screen shots that can be used as an exemplary template for “104” branded domains. In FIG. 3, an exemplary “104” branded website can include the brand-prefixed “104” logo 300, included on all such branded websites, followed by any suitable single word 301 to complete the domain. In FIG. 3, the brand-prefixed logo 300 is followed by a single word, for example, “Attorney.” Such consistency of a branded “prefix” followed by a “word” can increase the chances of a user recalling a website address and provides a uniform approach to reaching a website without needing to know the exact address thereof. With such methodology, advantageously, if a user is looking to get information on a local florist, for example, the user would know to type in “www.104florist.com,” “www.104flowers.com,” and the like, all of which could be valid “104” branded website addresses and provide the user with the desired information.

In an exemplary embodiment, business information, such as name, address, and phone#, can be retrieved after a user search, allowing the user to view a group of ten businesses 302 at a time related to the word 301. Such output of a group of ten businesses fulfills the double meaning of the brand-prefixed logo “104,” advantageously, indicating “10” businesses “4” word 301 for a user to view. In the example of FIG. 3, the user can view “10” businesses “4” an “Attorney” nearest to the user's geographical location. In addition, web search field 304, business search fields 305, menus items 306, 307 and 308 can also be provided.

FIG. 4 illustrates a further exemplary website with the brand-prefixed logo 300 followed by a single word 401, for example, “Loans.” The website of FIG. 4 would include all of the previous functionality described with respect to FIG. 3, except for the fields and portions 402, and 405 specific to the word 401.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Although the exemplary embodiments are described in terms of the branded prefix “104” having a secondary meaning (e.g., “ten four”), other prefixes can be employed, as will be appreciated by those skilled in the relevant art(s).

Although the exemplary embodiments are described in terms of employing geo-targeting technology, geo-targeting need not be employed, as will be appreciated by those skilled in the relevant art(s).

Advantageously, the exemplary embodiments can be applied to various sectors and organizations, including profit-based sectors and organizations, non-profit-based sectors and organizations, educational-based sectors and organizations and the like, while providing a reliable and trustworthy source of information, as will be appreciated by those skilled in the relevant art(s).

While the present inventions have been described in connection with a number of exemplary embodiments, and implementations, the present inventions are not so limited, but rather cover various modifications, and equivalent arrangements, which fall within the purview of present claims.

What is claimed is:

1. A computer implemented method for online advertising, the method comprising:
providing a branded prefix have a secondary meaning;
appending the branded prefix to a dictionary word suffix to form a domain name; and
displaying a web page based on the domain name and including one or more web page links,
wherein the one or more web page links within the web page are related to the dictionary word and the secondary meaning.

2. The method of claim 1, wherein the prefix is “104” and the secondary meaning is “ten four”.

3. The method of claim 2, wherein the one more web page links comprise ten web page links for the dictionary word.

4. A computer implemented system for performing one or more steps corresponding to the method of claim 1.

5. A computer program product embedded on a tangible computer readable medium for causing one or more computer processors to perform one or more of the processing steps corresponding to the method of claim 1.
